(19) United States
(12) Patent Application Publication
(10) Pub. No.: US 2026/0296842 A1
(43) Pub. Date: Oct. 1, 2026

(54) EARLY WARNING SYSTEM OF AUTOMATIC INSERTING PLATE FOR HOISTING ROTOR OF LARGE HYDRO-TURBINE GENERATOR SET AND EARLY WARNING METHOD THEREOF

(71) Applicant: CHINA YANGTZE POWER CO., LTD., Wuhan, Hubei (CN)

(72) Inventors: Tianming YAN, Wuhan, Hubei (CN); Xiangchu KONG, Wuhan, Hubei (CN); Xiaoying DONG, Wuhan, Hubei (CN); Daijun LIU, Wuhan, Hubei (CN); Yanqun ZHAO, Wuhan, Hubei (CN); Yanbing JI, Wuhan, Hubei (CN); Hao WU, Wuhan, Hubei (CN); Lesheng WANG, Wuhan, Hubei (CN)

(73) Assignee: CHINA YANGTZE POWER CO., LTD., Wuhan, Hubei (CN)

(21) Appl. No.: 19/476,707

(22) PCT Filed: May 6, 2024
(86) PCT No.: PCT/CN2024/091169

§ 371 Date: Oct. 19, 2025

(30) Foreign Application Priority Data
May 6, 2023 (CN) 202310504011.2

(51) Int. Cl. B66C 15/06; B66C 1/66; B66C 13/44

(52) U.S. Cl. CPC B66C 15/065; B66C 1/66; B66C 13/44

(57) ABSTRACT

Provided is an early warning system of an automatic inserting plate for hoisting a rotor of a large hydro-turbine generator set and an early warning method thereof. The early warning system includes an automatic inserting plate system and an alignment monitoring system; the inserting plate system includes a supporting mechanism and a moving mechanism; the supporting mechanism includes a base, an upper surface of the base is slidably connected with a host, and a power supply, a remote control module, a wireless module, and an alarm module are arranged inside the host; one end of the host is connected with the moving mechanism; the alignment monitoring system includes an over-current protection module and a laser alignment system, and the over-current protection module is arranged inside the host to be electrically connected with the power supply and the remote control module.

### FIELD

The present disclosure belongs to the field of hydro-generator overhaul technologies, and in particular relates to an early warning system of an automatic inserting plate for hoisting a rotor of a large hydro-turbine generator set and an early warning method thereof.

### BACKGROUND

A gap between a stator and a rotor of a large hydro-turbine generator set is small. There is a risk of collision and squeezing between the rotor and the stator when the rotor is hoisted in or out. Therefore, it is often necessary for operators to insert a plate between the stator and the rotor for protection and monitoring. The method of inserting a plate in the prior art is relatively simple, and a plurality of operators are required to stand around the periphery of the stator, respectively. Then, each operator holds a rope, and an inserting plate is tied at the bottom end of the rope. The operator needs to continuously twitch the rope to pull the inserting plate to slide up and down in the process of lowering the rotor, and feels whether the inserting plate is squeezed by the rotor and the stator through the stress of the hand contact. Therefore, the operator needs to climb up and down the stator and climb over a bus bar, which may lead to safety risks of working near an edge and being under a banging object. Moreover, the manner of pulling the inserting plate by hand is not only uneven in velocity, but also easy to make a misjudgment. There are also many problems such as untimely alarm feedback and untimely linkage with a crane after alarm. Therefore, it is necessary to design an early warning system of an automatic inserting plate for hoisting a rotor of a large hydro-turbine generator set and an early warning method thereof to solve the above problems.

### SUMMARY

The technical problem to be solved by the present disclosure is to provide an early warning system of an automatic inserting plate for hoisting a rotor of a large hydro-turbine generator set and an early warning method thereof. The system is used to solve the problems that in the process of hoisting and lowering the rotor of the existing hydro-turbine generator set, it is necessary to manually insert a plate to judge whether the rotor collides with an inner wall of a stator, which results in low efficiency, a high probability of misjudgment, and significant personnel operational risks. The system has the characteristics of automatically inserting a plate, which greatly saves labor, improves judgment accuracy, and eliminates personnel operational risks.

In order to solve the above technical problems, the technical solution used by the present disclosure is as follows.

An early warning system of an automatic inserting plate for hoisting a rotor of a large hydro-turbine generator set includes an automatic inserting plate system and an alignment monitoring system; the automatic inserting plate system includes a plurality of inserting plate mechanisms, the plurality of inserting plate mechanisms are circumferentially connected with an upper surface of a rotor; the inserting plate mechanism includes a supporting mechanism and a moving mechanism; the supporting mechanism includes a base, a lower surface of the base is connected with a magnetic sheet to be magnetically connected with the upper surface of the rotor; an upper surface of the base is slidably connected with a host, a power supply, a remote control module, a wireless module, and an alarm module are arranged inside the host, and the alarm module includes a three-color indicator light and a buzzer; one end of the host is connected with the moving mechanism; the alignment monitoring system includes an over-current protection module and a laser alignment system, and the over-current protection module is arranged inside the host to be electrically connected with the power supply and the remote control module.

Further, the over-current protection module uses an over-temperature and over-current protection module with model R-10A of LAMBODA brand.

Further, the remote control module selects a single chip microcomputer with STM32F103C8T6 model, the single chip microcomputer cooperates with the wireless module for remote control; the wireless module uses a Wi-Fi and Bluetooth module with HW-297 model; and the power supply uses a rechargeable lithium battery.

Preferably, the upper surface of the base is of a groove-shaped structure, and an inner wall of the groove-shaped structure is provided with a sliding rail to be slidably connected with the host.

Preferably, a side surface of the host is connected with a rack, a side surface of the groove-shaped structure is rotatably connected with an adjusting rod, and one end of the adjusting rod located in the groove-shaped structure is connected with a gear to be engaged with the rack; and one end of the adjusting rod located outside the groove-shaped structure is provided with a thread to be in threaded connection with a lock nut.

Further, the adjusting rod is rotatably connected with the groove-shaped structure through a bearing.

Preferably, the moving mechanism includes a support connected with one end of the host, an upper surface of the support is connected with a direct current motor, an output end of the direct current motor is connected with a winding roll, and a rigid rope is wound around a surface of the winding roll.

Further, the direct current motor is provided with a motor forward and backward rotation driving control module with RYC-FB001 model, and the motor forward and backward rotation driving control module is electrically connected with the remote control module.

Preferably, a side surface of the support is connected with a telescopic rod, an end of the telescopic rod is connected with a U-shaped frame, and an inner wall of the U-shaped frame is rotatably connected with a fixed pulley; and the other end of the rigid rope bypasses an upper surface of the fixed pulley to be connected with an inserting plate.

Further, the telescopic rod is of a sleeve structure formed by insertion and connection of hollow square pipes, a side surface of the sleeve structure is provided with jacks with equal intervals, and the jacks are fixed by pins.

Preferably, the inserting plate is slidably connected with a strip-shaped card slot, and a back side of the card slot is connected with a magnet to be magnetically connected with a side surface of the rotor; two sides of an inner wall of the card slot are provided with strip-shaped chutes to be slidably connected with the inserting plate, and a side surface of the inserting plate is connected with a strip-shaped slider to cooperate with the chute.

Preferably, the bottom of the card slot is connected with a spring, and the spring is connected with the bottom of the inserting plate through an elastic rope; and hooks are connected with the top and the bottom of the inserting plate to be hooked with the rigid rope or the elastic rope.

Preferably, the laser alignment system includes a plurality of laser ranging sensors; the laser ranging sensor is connected with an end of the telescopic rod at a front side of the inserting plate mechanism, an illumination direction of the laser ranging sensor is vertically downward, and a front end of each inserting plate mechanism is connected with a laser ranging sensor; all of the laser ranging sensors are electrically connected with the remote control module inside the host; and the plurality of laser ranging sensors form an annular illumination array to cooperate with a target mechanism below.

Further, the laser ranging sensor is preferably a laser ranging sensor of KJT TLS-01C, which can detect vertical or inclined targets within a distance of 30 m without being affected by color, material or gloss.

Preferably, the target mechanism includes a target ring with an annular structure, an upper surface of the target ring is a horizontal surface with an annular structure, and side surfaces of the target ring are all of a slope-like conical surface structure.

Further, the inclination of the side surface of the target ring is less than 30 degrees.

Further, the side surface of the target ring is connected with at least three threaded telescopic rods, and the ends of the threaded telescopic rods are connected with rubber mats.

Preferably, an early warning method of the early warning system of the automatic inserting plate for hoisting the rotor of the large hydro-turbine generator set includes the following steps:
S1, selecting a plurality of inserting plate mechanisms according to the specific requirements of the hoisting construction of the rotor; establishing a plane coordinate system with the center of the rotor as the origin, and labelling the plurality of inserting plate mechanisms with 1~n, where each label corresponds to a specific azimuth angle;
S2, arranging the plurality of inserting plate mechanisms on an upper surface of the rotor at equal intervals, and magnetically connecting the inserting plate mechanisms with the rotor through a magnetic sheet of a supporting mechanism;
S3, fixing a target ring below a stator, so that the center of the target ring coincides with the center of the stator, where an inner diameter of the target ring is larger than an outer diameter of the rotor,
S4, calibrating a laser alignment mechanism;
S401, starting a laser ranging sensor; and adjusting the length of a telescopic rod at an end of the inserting plate mechanism, so that a light spot of each laser ranging sensor falls on a horizontal plane of an annular structure on an upper surface of the target ring;
S402, adjusting the position of each host: loosening a lock nut, twisting an adjusting rod so that a gear cooperates with a rack, and driving the host to perform fine-tuning sliding forward along a base so that the light spots of all laser ranging sensors lie on the same circle; and recording an initial ranging value h of the laser ranging sensor at this time;
S5, sequentially adsorbing card slots on a side surface of the rotor directly below the laser ranging sensor, where each card slot is arranged in parallel with an axial direction of the rotor, then an inserting plate is slidably connected with the card slot through a chute structure, the top of the inserting plate is hooked with a rigid rope, and the bottom of the inserting plate is hooked with an elastic rope;
S6, starting a direct current motor, where the direct current motor is provided with a forward and backward rotation control module, periodic forward and backward rotation is performed according to a preset frequency, so that the inserting plate is pulled by the rigid rope to rise, and then the rigid rope is loosened, and the inserting plate descends under a tensile force of the elastic rope and the spring, so that the inserting plate performs up-and-down reciprocating motion within the card slot;
S7, lowering the rotor through a lifting device to give an early warning:
S701, in a lowering process, the three-color indicator light indicating the operating state: turning on a green light during normal operation, turning on a yellow light when power supply does not operate, and turning on a red light when deviation occurs;
S702, the inserting plate reciprocating in a gap between the rotor and a stator, where the gap between the stator and the rotor is too small when deviation occurs, the inserting plate is squeezed by the stator and the rotor, so that an instantaneous increase in the load pulled by the direct current motor and a rapid increase in the instantaneous current exceed a set maximum value, at this time, an over-current protection module starts over-current protection, the alarm module is driven to give a red light alarm, and an audio alarm is given by a buzzer;
S703, when deviation occurs, the light spot irradiated downward by some of the laser ranging sensors moving out of an annular horizontal plane of the target ring and falling on a conical surface outside the target ring; where at this time, the alarm module is also driven by the host to give a red light alarm, and an audio alarm is given by a buzzer;
S8, after deviation occurs, calculating and correcting the data by an alignment monitoring system:
S801, when the rotor deviates in a certain direction, monitoring that the inserting plate in a corresponding direction is squeezed, so that the inserting plate mechanism with the label starts the over-current protection module, obtains an azimuth angle α corresponding to the label m of the inserting plate mechanism, and locates the direction of (α+180°) as a readjustment and correction direction;
S802, obtaining the ranging data h1 corresponding to the laser ranging sensor with the label m, obtaining the lowering distance h2 of a crane, and calculating the standard height h3=h−h2 of the laser ranging sensor when the laser ranging sensor does not deviate, calculating the height difference Δh=h1−h3; then, calculating the deviation x through a known angle β of an inclined plane of the target ring according to a tangent function; and setting x as the readjustment and correction distance;
S803, scheduling a lifting device for adjustment according to the calculated data, so that the rotor moves in the readjustment and correction direction by a readjustment and correction distance, thereby completing quick correction and avoiding overcorrection and collision again;
S9, a remote control module being in communication connection with a terminal device through a wireless module, an operator checking various parameter data in a hoisting process through the terminal device, and controlling a related device of the host to reset, start and stop through the remote control module.

Further, in Step S702, according to the formula P=Fv, and P=UI, Fv=UI can be obtained. In the case of stable voltage and stable velocity, if the inserting plate is squeezed, the load increases rapidly, which leads to the increase of F. Therefore, the current I also increases, which exceeds the set value of over-current protection. The over-current protection acts at this time, and the device stops operating.

The present disclosure has the following beneficial effect.

The system greatly reduces the required number of operators. There is no need to operate by a plurality of operators by hand when inserting plates. The operation safety is improved. When the rotor is hoisted in and out, an inserting plate mechanism is used to replace the method of inserting plates manually, thereby avoiding the safety risks of working near an edge and being under a hanging object which exist when operators climb up and down the stator and climb over a bus bar, solving the safety risk problem of working environment of operators, and completing the rotor hoisting operation without manually inserting plates. The operation time is greatly shortened. With the original working method, hoisting the rotor out requires approximately 50 man-days. This method only takes 4 man-days, saving 92% of human resources alone. Through the alignment monitoring system, the carelessness of operators when manually inserting plates can be avoided. The interference from human experience factors can be reduced, so that the rotor hoisting process is safer, more stable, and more reliable. Additionally, the alignment monitoring system can provide real-time data about the deviation and the deviation direction through data calculation, facilitating precise readjustment and correction of the hoisting equipment. This not only avoids the risk of collision during readjustment, but also shortens the time required for error correction.

### BRIEF DESCRIPTION OF THE DRAWINGS

FIG. 1 is an overall schematic diagram of the present disclosure during hoisting;

FIG. 2 is a schematic front view of the present disclosure during hoisting;

FIG. 3 is a schematic front view of an inserting plate mechanism according to the present disclosure;

FIG. 4 is a structural schematic diagram of a supporting mechanism according to the present disclosure;

FIG. 5 is a schematic front view of a supporting mechanism according to the present disclosure;

FIG. 6 is a schematic side view of a supporting mechanism according to the present disclosure;

FIG. 7 is a structural schematic diagram of a moving mechanism according to the present disclosure;

FIG. 8 is a structural schematic diagram of a target mechanism according to the present disclosure; and

FIG. 9 is a schematic diagram of a wiring block diagram of a host according to the present disclosure.

In the figures: inserting mechanism 1, rotor 11, base 12, groove-shaped structure 121, magnetic sheet 13, host 14, support 141, direct current motor 142, telescopic rod 143, U-shaped frame 144, fixed pulley 145, winding roll 146, rigid rope 147, rack 15, adjusting rod 16, gear 17, lock nut 18, inserting plate 2, card slot 21, spring 22, elastic rope 23, laser ranging sensor 31, target ring 32, power supply 4, remote control module 5, wireless module 6, alarm module 7, terminal device 8.

### DETAILED DESCRIPTION

### Embodiment 1

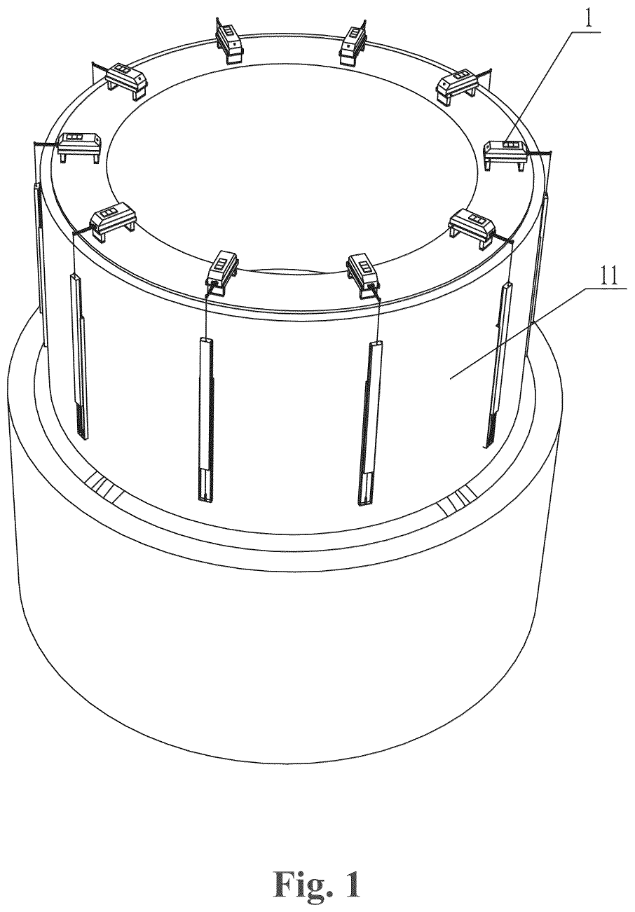

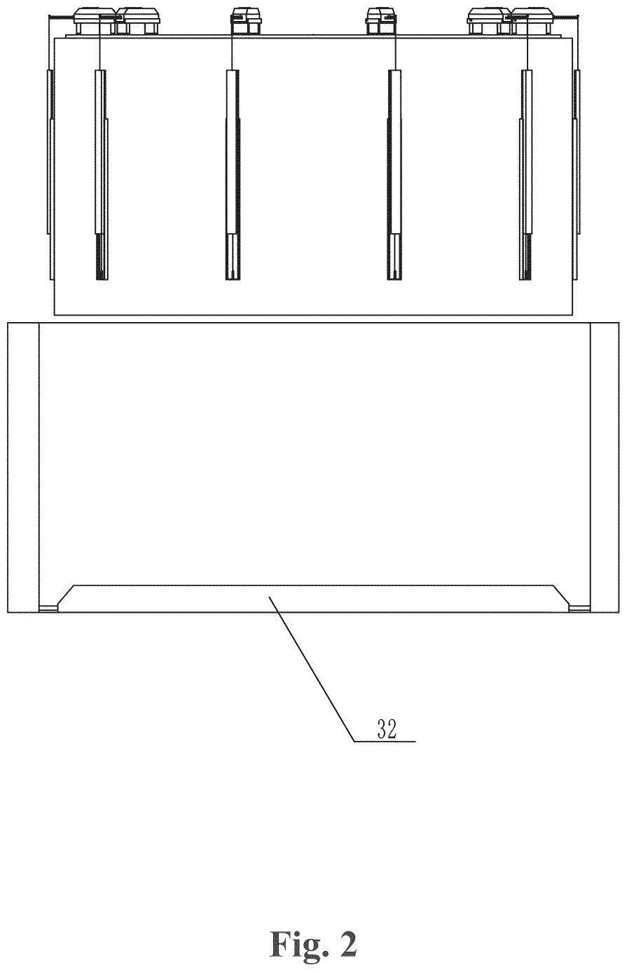

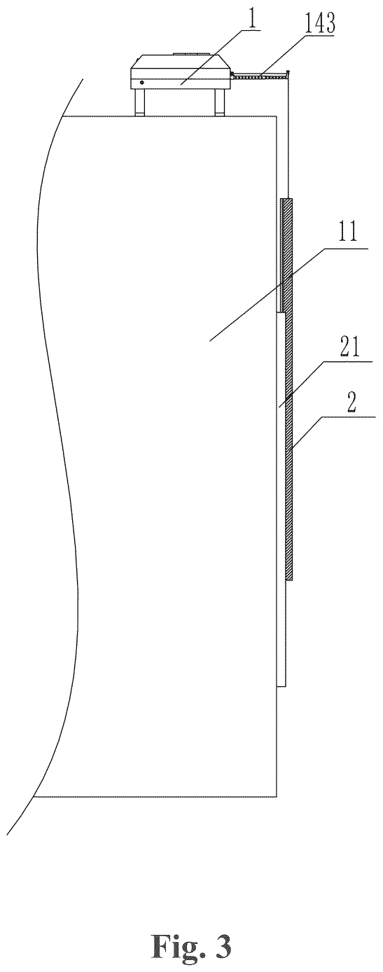

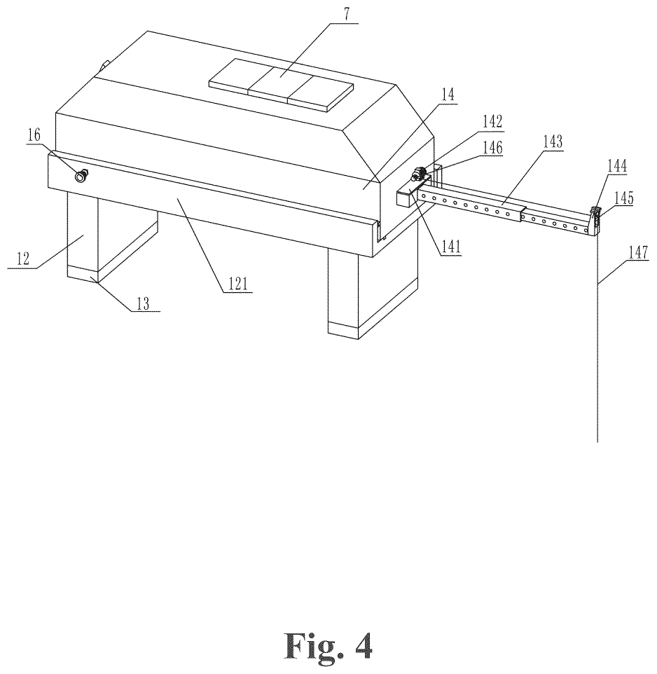

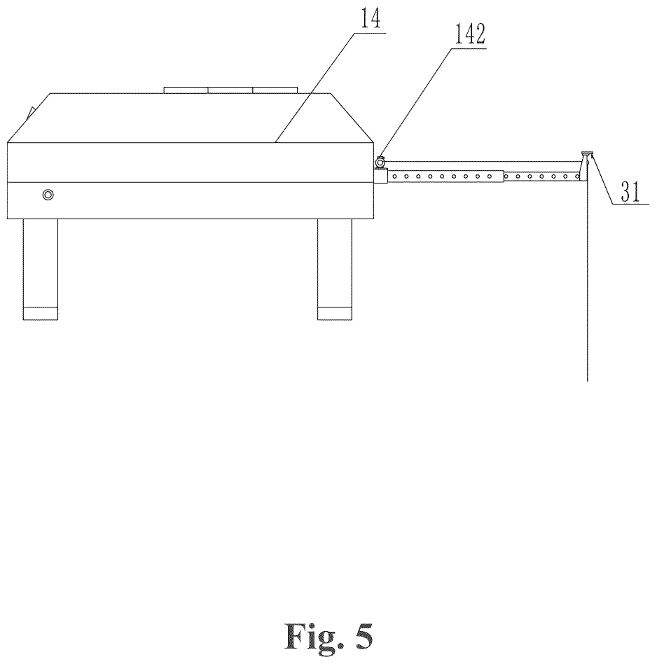

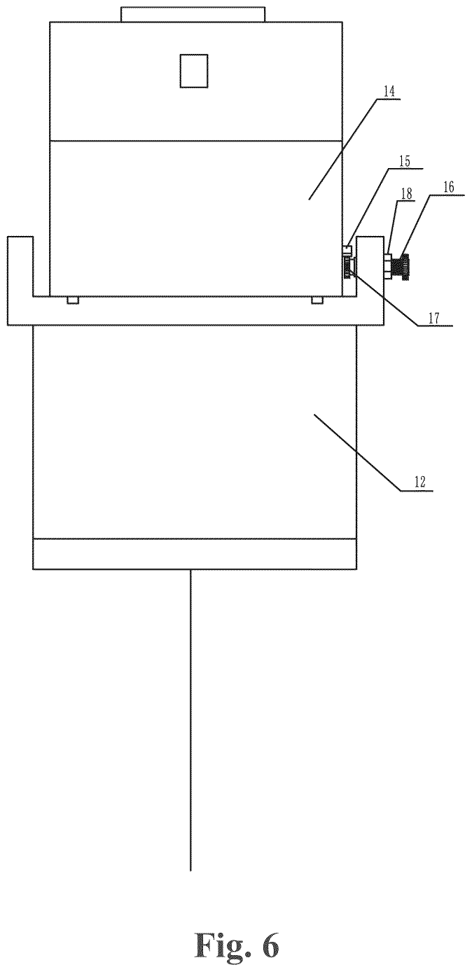

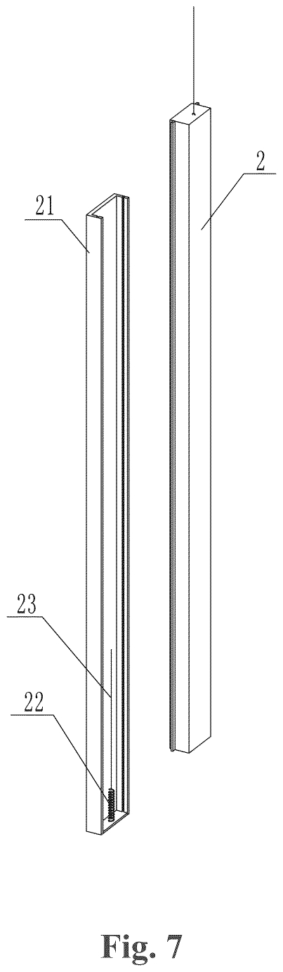

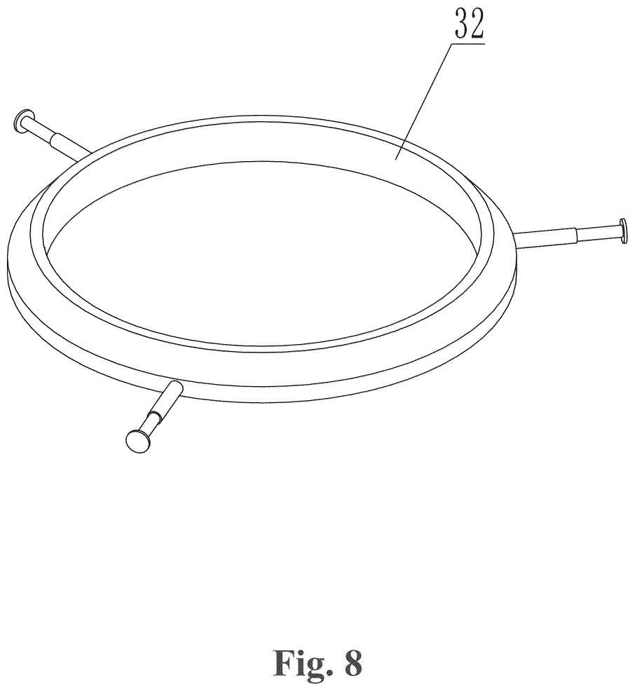

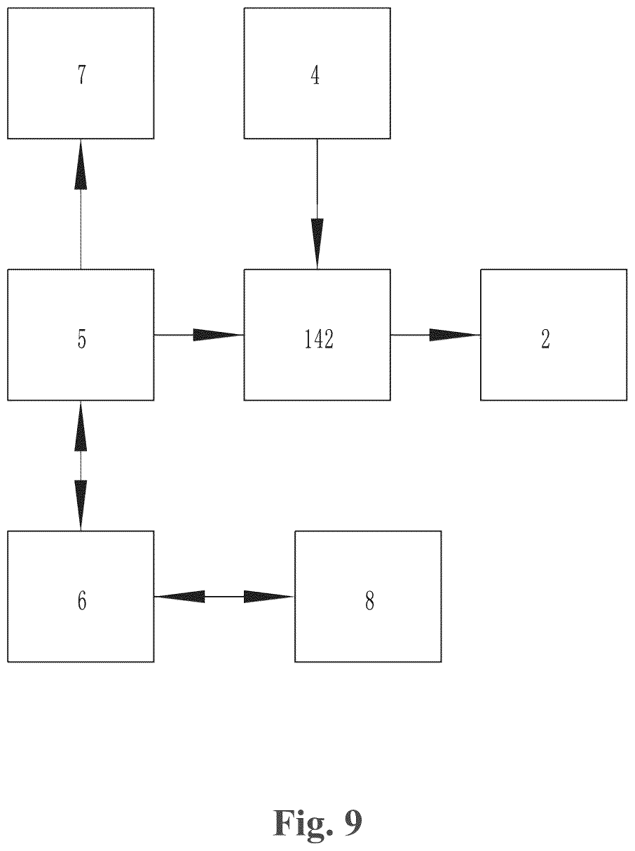

As shown in FIG. 1 to FIG. 9, an early warning system of an automatic inserting plate for hoisting a rotor of a large hydro-turbine generator set includes an automatic inserting plate system 2 and an alignment monitoring system; the automatic inserting plate system 2 includes a plurality of inserting plate mechanisms 1, the plurality of inserting plate mechanisms 1 are circumferentially connected with an upper surface of a rotor 11; the inserting plate mechanism 1 includes a supporting mechanism and a moving mechanism; the supporting mechanism includes a base 12, a lower surface of the base 12 is connected with a magnetic sheet 13 to be magnetically connected with the upper surface of the rotor 11; an upper surface of the base 12 is slidably connected with a host 14, a power supply 4, a remote control module 5, a wireless module 6, and an alarm module 7 are arranged inside the host 14, and the alarm module 7 includes a three-color indicator light and a buzzer, one end of the host 14 is connected with the moving mechanism; the alignment monitoring system includes an over-current protection module and a laser alignment system, and the over-current protection module is arranged inside the host 14 to be electrically connected with the power supply 4 and the remote control module 5.

Further, the over-current protection module uses an over-temperature and over-current protection module with model R-10A of LAMBODA brand.

Further, the remote control module 5 selects a single chip microcomputer with STM32F103C8T6 model, the single chip microcomputer cooperates with the wireless module 6 for remote control; the wireless module 6 uses a Wi-Fi and Bluetooth module with HW-297 model; and the power supply 4 uses a rechargeable lithium battery.

Preferably, the upper surface of the base 12 is of a groove-shaped structure 121, and an inner wall of the groove-shaped structure 121 is provided with a sliding rail to be slidably connected with the host 14.

Preferably, a side surface of the host 14 is connected with a rack 15, a side surface of the groove-shaped structure 121 is rotatably connected with an adjusting rod 16, and one end of the adjusting rod 16 located in the groove-shaped structure 121 is connected with a gear 17 to be engaged with the rack 15, and one end of the adjusting rod 16 located outside the groove-shaped structure 121 is provided with a thread to be in threaded connection with a lock nut 18.

Further, the adjusting rod 16 is rotatably connected with the groove-shaped structure 121 through a bearing.

Preferably, the moving mechanism includes a support 141 connected with one end of the host 14, an upper surface of the support 141 is connected with a direct current motor 142, an output end of the direct current motor 142 is connected with a winding roll 146, and a rigid rope 147 is wound around a surface of the winding roll 146.

Further, the direct current motor 142 is provided with a motor forward and backward rotation driving control module with RYC-FB001 model, and the motor forward and backward rotation driving control module is electrically connected with the remote control module 5.

Preferably, a side surface of the support 141 is connected with a telescopic rod 143, an end of the telescopic rod 143 is connected with a U-shaped frame 144, and an inner wall of the U-shaped frame 144 is rotatably connected with a fixed pulley 145; and the other end of the rigid rope 147 bypasses an upper surface of the fixed pulley 145 to be connected with an inserting plate 2.

Further, the telescopic rod 143 is of a sleeve structure formed by insertion and connection of hollow square pipes, a side surface of the sleeve structure is provided with jacks with equal intervals, and the jacks are fixed by pins.

Preferably, the inserting plate 2 is slidably connected with a strip-shaped card slot 21, and a back side of the card slot 21 is connected with a magnet to be magnetically connected with a side surface of the rotor 11; two sides of an inner wall of the card slot 21 are provided with strip-shaped chutes to be slidably connected with the inserting plate 2, and a side surface of the inserting plate 2 is connected with a strip-shaped slider to cooperate with the chute.

Preferably, the bottom of the card slot 21 is connected with a spring 22, and the spring 22 is connected with the bottom of the inserting plate 2 through an elastic rope 23; and hooks are connected with the top and the bottom of the inserting plate 2 to be hooked with the rigid rope 147 or the elastic rope 23.

Preferably, the laser alignment system includes a plurality of laser ranging sensors 31; the laser ranging sensor 31 is connected with an end of the telescopic rod 143 at a front side of the inserting plate mechanism 1, an illumination direction of the laser ranging sensor 31 is vertically downward, and a front end of each inserting plate mechanism 1 is connected with a laser ranging sensor 31; all of the laser ranging sensors 31 are electrically connected with the remote control module 5 inside the host 14; and the plurality of laser ranging sensors 31 form an annular illumination array to cooperate with a target mechanism below.

Further, the laser ranging sensor 31 is preferably a laser ranging sensor 31 of KJT TLS-01C, which can detect vertical or inclined targets within a distance of 30 m without being affected by color, material or gloss.

Preferably, the target mechanism includes a target ring 32 with an annular structure, an upper surface of the target ring 32 is a horizontal surface with an annular structure, and side surfaces of the target ring 32 are all of a slope-like conical surface structure.

Further, the inclination of the side surface of the target ring 32 is less than 30 degrees.

Further, the side surface of the target ring 32 is connected with at least three threaded telescopic rods 143, and the ends of the threaded telescopic rods 143 are connected with rubber mats.

### Embodiment 2

Preferably, an early warning method of the early warning system of the automatic inserting plate for hoisting the rotor of the large hydro-turbine generator set includes the following steps:
S1, selecting a plurality of inserting plate mechanisms 1 according to the specific requirements of the hoisting construction of the rotor 11; establishing a plane coordinate system with the center of the rotor 11 as the origin, and labelling the plurality of inserting plate mechanisms 1 with 1~n, where each label corresponds to a specific azimuth angle;
S2, arranging the plurality of inserting plate mechanisms 1 on an upper surface of the rotor 11 at equal intervals, and magnetically connecting the inserting plate mechanisms with the rotor 11 through a magnetic sheet 13 of a supporting mechanism;
S3, fixing a target ring 32 below a stator, so that the center of the target ring 32 coincides with the center of the stator, where an inner diameter of the target ring 32 is larger than an outer diameter of the rotor 11;
S4, calibrating a laser alignment mechanism;
S401, starting a laser ranging sensor 31; and adjusting the length of a telescopic rod 143 at an end of the inserting plate mechanism 1, so that a light spot of each laser ranging sensor 31 falls on a horizontal plane of an annular structure on an upper surface of the target ring 32;
S402, adjusting the position of each host 14: loosening a lock nut 18, twisting an adjusting rod 16 so that a gear 17 cooperates with a rack 15, and driving the host 14 to perform fine-tuning sliding forward along a base 12 so that the light spots of all laser ranging sensors 31 lie on the same circle; and recording an initial ranging value h of the laser ranging sensor 31 at this time;
S5, sequentially adsorbing card slots 21 on a side surface of the rotor 11 directly below the laser ranging sensor 31, where each card slot 21 is arranged in parallel with an axial direction of the rotor 11, then an inserting plate 2 is slidably connected with the card slot 21 through a chute structure, the top of the inserting plate 2 is hooked with a rigid rope 147, and the bottom of the inserting plate is hooked with an elastic rope 23;
S6, starting a direct current motor 142, where the direct current motor 142 is provided with a forward and backward rotation control module, periodic forward and backward rotation is performed according to a preset frequency, so that the inserting plate 2 is pulled by the rigid rope 147 to rise, and then the rigid rope 147 is loosened, and the inserting plate 2 descends under a tensile force of the elastic rope 23 and the spring 22, so that the inserting plate 2 performs up-and-down reciprocating motion within the card slot 21;
S7, lowering the rotor 11 through a lifting device to give an early warning:
S701, in a lowering process, the three-color indicator light indicating the operating state: turning on a green light during normal operation, turning on a yellow light when power supply does not operate, and turning on a red light when deviation occurs;
S702, the inserting plate 2 reciprocating in a gap between the rotor 11 and a stator, where a gap between the stator and the rotor 11 is too small when deviation occurs, the inserting plate 2 is squeezed by the stator and the rotor 11, so that an instantaneous increase in the load pulled by the direct current motor 142 and a rapid increase in the instantaneous current exceed a set maximum value, at this time, an over-current protection module starts over-current protection, the alarm module is driven to give a red light alarm, and an audio alarm is given by a buzzer;
S703, when deviation occurs, the light spot irradiated downward by some of the laser ranging sensors 31 moving out of an annular horizontal plane of the target ring 32 and falling on a conical surface outside the target ring 32; where at this time, the alarm module 7 is also driven by the host 14 to give a red light alarm, and an audio alarm is given by a buzzer;
S8, after deviation occurs, calculating and correcting the data by an alignment monitoring system:
S801, when the rotor 11 deviates in a certain direction, monitoring that the inserting plate 2 in a corresponding direction is squeezed, so that the inserting plate mechanism 1 with the label starts the over-current protection module, obtains an azimuth angle α corresponding to the label m of the inserting plate mechanism 1, and locates the direction of (α+180°) as a readjustment and correction direction;
S802, obtaining the ranging data h1 corresponding to the laser ranging sensor 31 with the label m, obtaining the lowering distance h2 of a crane, and calculating the standard height h3=h−h2 of the laser ranging sensor 31 when the laser ranging sensor does not deviate; calculating the height difference Δh=h1−h3; then, calculating the deviation x through a known angle β of an inclined plane of the target ring 32 according to a tangent function; and setting x as the readjustment and correction distance;
S803, scheduling a lifting device for adjustment according to the calculated data, so that the rotor 11 moves in the readjustment and correction direction by a readjustment and correction distance, thereby completing quick correction and avoiding overcorrection and collision again;
S9, a remote control module 5 being in communication connection with a terminal device 8 through a wireless module 6, an operator checking various parameter data in a hoisting process through the terminal device 8, and controlling a related device of the host 14 to reset, start and stop through the remote control module 5.

Further, in Step S702, according to the formula P=Fv, and P=UI, Fv=UI can be obtained. In the case of stable voltage and stable velocity, if the inserting plate 2 is squeezed, the load increases rapidly, which leads to the increase of F. Therefore, the current I also increases, which exceeds the set value of over-current protection. The over-current protection acts at this time, and the device stops operating.

The above embodiments are only the preferred technical solutions of the present disclosure, and should not be regarded as limitations of the present disclosure. The embodiments in the present disclosure and the features in the embodiments can be arbitrarily combined with each other without conflict. The scope of protection of the present disclosure shall be based on the technical solution described in the claims, including the equivalent alternatives of technical features in the technical solution described in the claims. That is, equivalent substitution and improvement within this scope also fall within the scope of protection of the present disclosure.

1. An early warning system of an automatic inserting plate for hoisting a rotor of a large hydro-turbine generator set, comprising an automatic inserting plate system and an alignment monitoring system;
the automatic inserting plate system comprises a plurality of inserting plate mechanisms (1), the plurality of inserting plate mechanisms (1) are circumferentially connected with an upper surface of a rotor (11);
the inserting plate mechanism (1) comprises a supporting mechanism and a moving mechanism,
the supporting mechanism comprises a base (12), a lower surface of the base (12) is connected with a magnetic sheet (13) to be magnetically connected with the upper surface of the rotor (11);
an upper surface of the base (12) is slidably connected with a host (14), a power supply (4), a remote control module (5), a wireless module (6), and an alarm module (7) are arranged inside the host (14), and the alarm module comprises a three-color indicator light and a buzzer;
one end of the host (14) is connected with the moving mechanism;
the alignment monitoring system comprises an over-current protection module and a laser alignment system, and the over-current protection module is arranged inside the host (14) to be electrically connected with the power supply and the remote control module.

2. The early warning system of the automatic inserting plate for hoisting the rotor of the large hydro-turbine generator set according to claim 1, wherein the upper surface of the base (12) is of a groove-shaped structure (121), and an inner wall of the groove-shaped structure (121) is provided with a sliding rail to be slidably connected with the host (14).

3. The early warning system of the automatic inserting plate for hoisting the rotor of the large hydro-turbine generator set according to claim 2, wherein a side surface of the host (14) is connected with a rack (15), a side surface of the groove-shaped structure (121) is rotatably connected with an adjusting rod (16), and one end of the adjusting rod (16) located in the groove-shaped structure (121) is connected with a gear (17) to be engaged with the rack (15); and one end of the adjusting rod (16) located outside the groove-shaped structure (121) is provided with a thread to be in threaded connection with a lock nut (18).

4. The early warning system of the automatic inserting plate for hoisting the rotor of the large hydro-turbine generator set according to claim 3, wherein the moving mechanism comprises a support (141) connected with one end of the host (14), an upper surface of the support (141) is connected with a direct current motor (142), an output end of the direct current motor (142) is connected with a winding roll (146), and a rigid rope (147) is wound around a surface of the winding roll (146).

5. The early warning system of the automatic inserting plate for hoisting the rotor of the large hydro-turbine generator set according to claim 4, wherein a side surface of the support (141) is connected with a telescopic rod (143), an end of the telescopic rod (143) is connected with a U-shaped frame (144), and an inner wall of the U-shaped frame (144) is rotatably connected with a fixed pulley (145); and the other end of the rigid rope (147) bypasses an upper surface of the fixed pulley (145) to be connected with an inserting plate (2).

6. The early warning system of the automatic inserting plate for hoisting the rotor of the large hydro-turbine generator set according to claim 5, wherein the inserting plate (2) is slidably connected with a strip-shaped card slot (21), and a back side of the card slot (21) is connected with a magnet to be magnetically connected with a side surface of the rotor (11); two sides of an inner wall of the card slot (21) are provided with strip-shaped chutes to be slidably connected with the inserting plate (2), and a side surface of the inserting plate (2) is connected with a strip-shaped slider to cooperate with the chute.

7. The early warning system of the automatic inserting plate for hoisting the rotor of the large hydro-turbine generator set according to claim 6, wherein the bottom of the card slot (21) is connected with a spring (22), and the spring (22) is connected with the bottom of the inserting plate (2) through an elastic rope (23), and hooks are connected with the top and the bottom of the inserting plate (2) to be hooked with the rigid rope (147) or the elastic rope (23).

8. The early warning system of the automatic inserting plate for hoisting the rotor of the large hydro-turbine generator set according to claim 7, wherein the laser alignment system comprises a plurality of laser ranging sensors (31); the laser ranging sensor (31) is connected with an end of the telescopic rod (143) at a front side of the inserting plate mechanism (1), an illumination direction of the laser ranging sensor (31) is vertically downward, and a front end of each inserting plate mechanism (1) is connected with a laser ranging sensor (31); all of the laser ranging sensors (31) are electrically connected with the remote control module inside the host (14); and the plurality of laser ranging sensors (31) form an annular illumination array to cooperate with a target mechanism below.

9. The early warning system of the automatic inserting plate for hoisting the rotor of the large hydro-turbine generator set according to claim 8, wherein the target mechanism comprises a target ring (32) with an annular structure, an upper surface of the target ring (32) is a horizontal surface with an annular structure, and side surfaces of the target ring (32) are all of a slope-like conical surface structure.

10. An early warning method of the early warning system of the automatic inserting plate for hoisting the rotor of the large hydro-turbine generator set according to claim 9, comprising the following steps:
S1, selecting a plurality of inserting plate mechanisms (1) according to the specific requirements of the hoisting construction of the rotor (11); establishing a plane coordinate system with the center of the rotor (11) as the origin, and labelling the plurality of inserting plate mechanisms (1) with 1~n, wherein each label corresponds to a specific azimuth angle;
S2, arranging the plurality of inserting plate mechanisms (1) on an upper surface of the rotor (11) at equal intervals, and magnetically connecting the inserting plate mechanisms with the rotor (11) through a magnetic sheet (13) of a supporting mechanism;
S3, fixing a target ring (32) below a stator, so that the center of the target ring (32) coincides with the center of the stator; wherein an inner diameter of the target ring (32) is larger than an outer diameter of the rotor (11);
S4, calibrating a laser alignment mechanism;
S401, starting a laser ranging sensor (31); and adjusting the length of a telescopic rod (143) at an end of the inserting plate mechanism (1), so that a light spot of each laser ranging sensor (31) falls on a horizontal plane of an annular structure on an upper surface of the target ring (32);
S402, adjusting the position of each host (14): loosening a lock nut (18), twisting an adjusting rod (16) so that a gear (17) cooperates with a rack (15), and driving the host (14) to perform fine-tuning sliding forward along a base (12) so that the light spots of all laser ranging sensors (31) lie on the same circle, and recording an initial ranging value h of the laser ranging sensor (31) at this time;
S5, sequentially adsorbing card slots (21) on a side surface of the rotor (11) directly below the laser ranging sensor (31), wherein each card slot (21) is arranged in parallel with an axial direction of the rotor (11); then an inserting plate is slidably connected with the card slot (21) through a chute structure, the top of the inserting plate (2) is hooked with a rigid rope (147), and the bottom of the inserting plate is hooked with an elastic rope (23);
S6, starting a direct current motor (142), wherein the direct current motor (142) is provided with a forward and backward rotation control module, periodic forward and backward rotation is performed according to a preset frequency, so that the inserting plate (2) is pulled by the rigid rope (147) to rise, and then the rigid rope (147) is loosened, and the inserting plate (2) descends under a tensile force of the elastic rope (23) and the spring (22), so that the inserting plate (2) performs up-and-down reciprocating motion within the card slot (21);
S7, lowering the rotor (11) through a lifting device to give an early warning:
S701, in a lowering process, the three-color indicator light indicating the operating state: turning on a green light during normal operation, turning on a yellow light when power supply does not operate, and turning on a red light when deviation occurs;
S702, the inserting plate (2) reciprocating in a gap between the rotor (11) and a stator, wherein the gap between the stator and the rotor is too small when deviation occurs, the inserting plate (2) is squeezed by the stator and the rotor (11), so that an instantaneous increase in the load pulled by the direct current motor (142) and a rapid increase in the instantaneous current exceed a set maximum value, at this time, an over-current protection module starts over-current protection, the alarm module is driven to give a red light alarm, and an audio alarm is given by a buzzer;
S703, when deviation occurs, the light spot irradiated downward by some of the laser ranging sensors (31) moving out of an annular horizontal plane of the target ring (32) and falling on a conical surface outside the target ring (32); wherein at this time, the alarm module is also driven by the host (14) to give a red light alarm, and an audio alarm is given by a buzzer;
S8, after deviation occurs, calculating and correcting the data by an alignment monitoring system:
S801, when the rotor (11) deviates in a certain direction, monitoring that the inserting plate (2) in a corresponding direction is squeezed, so that the inserting plate mechanism (1) with the label starts the over-current protection module, obtains an azimuth angle α corresponding to the label m of the inserting plate mechanism (1), and locates the direction of (α+180°) as a readjustment and correction direction;
S802, obtaining the ranging data h1 corresponding to the laser ranging sensor (31) with the label m, obtaining the lowering distance h2 of a crane, and calculating the standard height h3=h−h2 of the laser ranging sensor (31) when the laser ranging sensor does not deviate; calculating the height difference Δh=h1−h3; then, calculating the deviation x through a known angle β of an inclined plane of the target ring (32) according to a tangent function; and setting x as the readjustment and correction distance;
S803, scheduling a lifting device for adjustment according to the calculated data, so that the rotor (11) moves in the readjustment and correction direction by a readjustment and correction distance, thereby completing quick correction and avoiding overcorrection and collision again;
S9, a remote control module being in communication connection with a terminal device through a wireless module, an operator checking various parameter data in a hoisting process through the terminal device, and controlling a related device of the host (14) to reset, start and stop through the remote control module.
